(19) United States
(12) Patent Application Publication
(10) Pub. No.: US 2023/0242407 A1
(43) Pub. Date: Aug. 3, 2023

(54) CONDUCTIVE TWO-DIMENSIONAL PARTICLE AND METHOD FOR PRODUCING SAME, CONDUCTIVE FILM, CONDUCTIVE COMPOSITE MATERIAL, AND CONDUCTIVE PASTE

(71) Applicant: Murata Manufacturing Co., Ltd., Nagaokakyo-shi (JP)

(72) Inventors: Masashi KOYANAGI, Nagaokakyo-shi (JP); Takeshi TORITA, Nagaokakyo-shi (JP); Masanori ABE, Nagaokakyo-shi (JP); Kosuke SUGIURA, Nagaokakyo-shi (JP); Akimaro YANAGIMACHI, Nagaokakyo-shi (JP); Yuusuke OGAWA, Nagaokakyo-shi (JP)

(21) Appl. No.: 18/299,274

(22) Filed: Apr. 12, 2023

Related U.S. Application Data
(63) Continuation of application No. PCT/JP2021/037602, filed on Oct. 11, 2021.

(30) Foreign Application Priority Data
Oct. 15, 2020 (JP) 2020-173896

(51) Int. Cl. C01B 32/921; H01B 1/20

(52) U.S. Cl. CPC C01B 32/921; H01B 1/20; C01P 2006/40; C01P 2004/20; C01P 2004/60; C01P 2002/74; C01P 2006/80

(57) ABSTRACT

Electroconductive two-dimensional particles composed of a layered material having one or more layers, wherein each of the one or more layers is a layer body represented by MₘXₙ (M represents at least one group 3, 4, 5, 6 or 7 metal; X represents a carbon atom, a nitrogen atom, or a combination thereof; n represents a number from 1 to 4; m represents a number that is larger than n but not larger than 5), and a modification or terminal T (T represents at least one atom or group selected from a hydroxyl group, a fluorine atom, a chlorine atom, an oxygen atom and a hydrogen atom) is present on the surface of the layer body; the Li content is from 0.0001% by mass to 0.0020% by mass; and the average value of the lengths of two-dimensional surfaces of the electroconductive two-dimensional particles is from 1.0 μm to 20 μm.

### CROSS REFERENCE TO RELATED APPLICATIONS

The present application is a continuation of International application No. PCT/JP2021/037602, filed Oct. 11, 2021, which claims priority to Japanese Patent Application No. 2020-173896, filed Oct. 15, 2020, the entire contents of each of which are incorporated herein by reference.

### FIELD OF THE INVENTION

The present invention relates to a conductive two-dimensional particle and a method for producing same, a conductive film, a conductive composite material, and a conductive paste

### BACKGROUND OF THE INVENTION

In recent years, MXene has been attracting attention as a new material having conductivity. MXene is a type of so-called two-dimensional material and, as will be described later, is a layered material in the form of one or plural layers. In general, MXene is in the form of particles (which can include powders, flakes, nanosheets, and the like) of such a layered material.

Currently, various studies are being conducted toward the application of MXene to various electrical devices. For the above application, it is required to further enhance the conductivity of a material containing MXene. As a part of the study, a delamination method of MXene obtained as a multilayered product has been studied, and as one of the delamination methods, a delamination method using Li as an intercalant has been proposed. However, when Li is used for intercalation, there is a problem that moisture absorption resistance is poor and a resistance change is large.

In response to the above problem, Non-Patent Document 1 discloses that Li ions are removed from MXene by adding hydrochloric acid or the like to a suspension obtained by intercalation using Li to adjust the pH to about 2.9. In addition, Non-Patent Document 2 discloses that delamination of the multilayer MXene was performed by using TMAOH (tetramethylammonium hydroxide) as a dispersant instead of Li.

Non-Patent Document 1: Pristine Titanium Carbide MXene Films with Environmentally Stable Conductivity and Superior Mechanical Strength (Adv. Funct. Mater. 2020, 30, 1906996)

Non-Patent Document 2: Guidelines for Synthesis and Processing of Two-Dimensional Titanium Carbide (Ti3C2Tx MXene) Chem. Mater. 2017, 29, 7633-7644

### SUMMARY OF THE INVENTION

In the technique of Non-Patent Document 1, the resistance change is small, but the effect is not sufficient. In Non-Patent Document 2, Li is not used, and the problem caused by Li does not occur, but TMAOH used as a dispersant remains in MXene, and the conductivity is low due to the remaining TMAOH. In addition, it is considered that when a highly polar molecule such as TMAOH remains, moisture is easily absorbed, and the resistance change is also large. The present invention has been made in view of the above circumstances, and an object thereof is to provide a conductive two-dimensional particle capable of forming a conductive film having a small resistance change and exhibiting high conductivity, a conductive film exhibiting high conductivity, a method for producing the conductive two-dimensional particle, and a conductive composite material and a conductive paste using the conductive two-dimensional particle.

According to one aspect of the present invention, there is provided a conductive two-dimensional particle of a layered material including: one or more layers, wherein the one or more layers include a layer body represented by: MₘXₙ wherein M is at least one metal of Group 3, 4, 5, 6, or 7, X is a carbon atom, a nitrogen atom, or a combination thereof, n is 1 to 4, and m is more than n and 5 or less, and a modifier or terminal T exists on a surface of the layer body, wherein T is at least one selected from the group consisting of a hydroxyl group, a fluorine atom, a chlorine atom, an oxygen atom, or a hydrogen atom, a Li content is 0.0001 mass % to 0.0020 mass %, and an average value of major diameters of two-dimensional surfaces of the conductive two-dimensional particles is 1.0 μm to 20 μm.

According to another aspect of the present invention, there is provided a method for producing a conductive two-dimensional particle, the method including: (a) preparing a precursor, the precursor represented by: MₘAXₙ wherein M is at least one metal of Group 3, 4, 5, 6, or 7, X is a carbon atom, a nitrogen atom, or a combination thereof, A is at least one element of Group 12, 13, 14, 15, or 16, n is 1 to 4, and m is more than n and 5 or less; (b1) performing an etching treatment of removing at least a part of the A atoms from the precursor using an etching solution; (c) performing Li intercalation treatment that includes mixing and stirring an etched product obtained by the etching treatment and a Li-containing compound; (d) performing a delamination treatment that includes centrifuging a Li intercalated product obtained by the Li intercalation treatment, discarding a supernatant, and then washing a remaining precipitate with water; (e) performing an acid treatment that includes mixing and stirring a delaminated product obtained by the delamination treatment and an acid solution; and (f) washing an acid-treated product obtained by the acid treatment with water to obtain a conductive two-dimensional particle, wherein a Li content in the conductive two-dimensional particles is 0.0020 mass % or less.

According to the present invention, there is provided a conductive two-dimensional particle which is formed of a predetermined layered material (also referred to as “MXene” in the present specification), a Li content is 0.0001 mass % to 0.0020 mass %, in which an average value of major diameters of two-dimensional surfaces of the conductive two-dimensional particle is 1.0 μm to 20 μm. With this, the conductive two-dimensional particle contains MXene, is capable of forming a conductive film exhibiting small resistance change and high conductivity.

According to the present invention, the conductive two-dimensional particle having a Li content of 0.0020 mass % or less is produced by the method including (a) preparing a predetermined precursor; (b1) performing an etching treatment of removing at least a part of the A atoms from the precursor using an etching solution; (c) performing Li intercalation treatment that includes mixing and stirring an etched product obtained by the etching treatment and a Li-containing compound; (d) performing a delamination treatment that includes centrifuging a Li intercalated product obtained by the Li intercalation treatment, discarding a supernatant, and then washing a remaining precipitate with water; (e) performing an acid treatment that includes mixing and stirring a delaminated product obtained by the delamination treatment and an acid solution; and (f) washing an acid-treated product obtained by the acid treatment with water.

### BRIEF DESCRIPTION OF THE DRAWINGS

FIGS. 1(a) and 1(b) are schematic cross-sectional views illustrating MXene which is a layered material usable for a conductive film in one aspect of the present embodiment, in which FIG. 1(a) illustrates single-layer MXene, and FIG. 1(b) illustrates multi-layered (exemplarily two-layered) MXene.

FIG. 2 is a diagram for explaining an interlayer distance in MXene particles according to the present invention.

FIGS. 3(a) and 3(b) are diagrams illustrating a conductive film in one embodiment of the present invention, in which FIG. 3(a) illustrates a schematic cross-sectional view of the conductive film, and FIG. 3(b) illustrates a schematic perspective view of MXene particles in the conductive film.

FIG. 4 is a schematic cross-sectional view illustrating a conductive film according to another embodiment of the present invention.

FIG. 5 is a scanning electron microscope of conductive two-dimensional particles (MXene particles) produced in example 1.

FIG. 6 is a view illustrating X-ray diffraction measurement results in examples.

### DETAILED DESCRIPTION OF THE INVENTION

### First Embodiment: Conductive Two-Dimensional Particle

Hereinafter, a conductive two-dimensional particle in one embodiment of the present invention will be described in detail, but the present invention is not limited to such an embodiment.

The conductive two-dimensional particle in the present embodiment is a conductive two-dimensional particle of a layered material includes: one or more layers, wherein the one or more layers include a layer body (the layer body may have a crystal lattice in which each X is located in an octahedral array of M) represented by:

MₘXₙ

wherein M is at least one metal of Group 3, 4, 5, 6, or 7,

X is a carbon atom, a nitrogen atom, or a combination thereof,

n is 1 to 4,

m is more than n and 5 or less, and

a modifier or terminal T exists on a surface (more particularly, at least one of the two opposing surfaces of the layer body) of the layer body, wherein T is at least one selected from the group consisting of a hydroxyl group, a fluorine atom, a chlorine atom, an oxygen atom, or a hydrogen atom.

The layered material can be understood as a layered compound and is also denoted by “MₘXₙTₛ”, in which s is an optional number, and in the related art, x or z may be used instead of s. Typically, n can be 1, 2, 3, or 4, but is not limited thereto.

In the above formula of MXene, M is preferably at least one selected from the group consisting of Ti, Zr, Hf, V, Nb, Ta, Cr, Mo, or Mn, and more preferably at least one selected from the group consisting of Ti, V, Cr, or Mo.

MXenes whose above formula MₘXₙ is expressed as below are known:

Sc₂C, Ti₂C, Ti₂N, Zr₂C, Zr₂N, Hf₂C, Hf₂N, V₂C, V₂N, Nb₂C, Ta₂C, Cr₂C, Cr₂N, Mo₂C, Mo_{1.3}C, Cr_{1.3}C, (Ti,V)₂C, (Ti,Nb)₂C, W₂C, W_{1.3}C, Mo₂N, Nb_{1.3}C, Mo_{1.3}Y_{0.6}C (in the above formula, “1.3” and “0.6” mean about 1.3 (=4/3) and about 0.6 (=2/3), respectively.),

Ti₃C₂, Ti₃N₂, Ti₃(CN), Zr₃C₂, (Ti,V)₃C₂, (Ti₂Nb)C₂, (Ti₂Ta)C₂, (Ti₂Mn)C₂, Hf₃C₂, (Hf₂V) C₂, (Hf₂Mn) C₂, (V₂Ti) C₂, (Cr₂Ti) C₂, (Cr₂V) C₂, (Cr₂Nb) C₂, (Cr₂Ta) C₂, (Mo₂Sc) C₂, (Mo₂Ti) C₂, (Mo₂Zr) C₂, (Mo₂Hf) C₂, (Mo₂V) C₂, (Mo₂Nb) C₂, (Mo₂Ta) C₂, (W₂Ti) C₂, (W₂Zr) C₂, (W₂Hf) C₂,

Ti₄N₃, V₄C₃, Nb₄C₃, Ta₄C₃, (Ti,Nb)₄C₃, (Nb, Zr)₄C₃, (Ti₂Nb₂) C₃, (Ti₂Ta₂) C₃, (V₂Ti₂) C₃, (V₂Nb₂) C₃, (V₂Ta₂) C₃, (Nb₂Ta₂) C₃, (Cr₂Ti₂) C₃, (Cr₂V₂) C₃, (Cr₂Nb₂) C₃, (Cr₂Ta₂) C₃, (Mo₂Ti₂) C₃, (Mo₂Zr₂) C₃, (Mo₂Hf₂) C₃, (Mo₂V₂) C₃, (Mo₂Nb₂) C₃, (Mo₂Ta₂) C₃, (W₂Ti₂) C₃, (W₂Zr₂)C₃, (W₂Hf₂)C₃, (Mo_{2.7}V_{1.3})C₃ (in the above formula, “2.7” and “1.3” mean about 2.7 (=8/3) and about 1.3 (=4/3), respectively.)

Typically, in the above formula, M can be titanium or vanadium and X can be a carbon atom or a nitrogen atom. For example, the MAX phase is Ti₃AlC₂ and MXene is Ti₃C₂Tₛ (in other words, M is Ti, X is C, n is 2, and m is 3).

It is noted that in the present invention, MXene may contain remaining A atoms at a relatively small amount, for example, at 10 mass % or less with respect to the original amount of A atoms. The remaining amount of A atoms can be preferably 8 mass % or less, and more preferably 6 mass % or less. However, even if the residual amount of A atoms exceeds 10 mass %, there may be no problem depending on the application and use conditions of the conductive two-dimensional particle.

In the present specification, the conductive two-dimensional particle (MXene particle) refers to a particle formed of the MXene and having a ratio of (average value of major diameters of two-dimensional surfaces of MXene particles)/(average value of thicknesses of MXene particles) of 1.2 or more, preferably 1.5 or more, and more preferably 2 or more. The average value of the major diameters of the two-dimensional surfaces of the MXene particles and the average value of the thicknesses of the MXene particles may be obtained by a method to be described later.

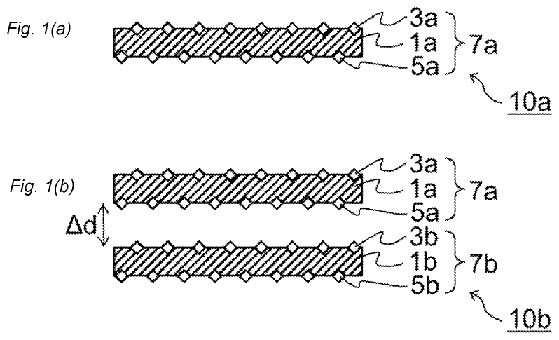

The conductive two-dimensional particle of the present embodiment is an aggregate containing one layer of MXene 10a (single-layer MXene) schematically illustrated in FIG. 1(a). More specifically, MXene 10a is an MXene layer 7a having layer body (MₘXₙ layer) 1a represented by MₘXₙ, and modifier or terminals T3a and 5a existing on the surface (more specifically, at least one of two surfaces facing each other in each layer) of the layer body 1a. Therefore, the MXene layer 7a is also represented as “MₘXₙTₛ”, and s is an optional number.

The conductive two-dimensional particle of the present embodiment may include one layer or plural layers. Examples of the MXene (multilayer MXene) of the plural layers include, but are not limited to, two layers of MXene 10b as schematically illustrated in FIG. 1(b). 1b, 3b, 5b, and 7b in FIG. 1(b) are the same as 1a, 3a, 5a, and 7a in FIG. 1(a) described above. Two adjacent MXene layers (for example, 7a and 7b) of the multilayer MXene do not necessarily have to be completely separated from each other, and may be partially in contact with each other. The MXene 10a may be a mixture of the single-layer MXene 10a and the multilayer MXene 10b, in which the multilayer MXene 10b is individually separated and exists as one layer and the unseparated multilayer MXene 10b remains.

Although the present embodiment is not limited, the thickness of each layer of MXene (which corresponds to the MXene layers 7a and 7b) is, for example, 0.8 nm to 10 nm, further 0.8 nm to 5 nm, particularly 0.8 nm to 3 nm (which may mainly vary depending on the number of M atom layers included in each layer). For the individual laminates of the multilayer MXene that can be included, the interlayer distance (alternatively, a void dimension is indicated by Δd in FIG. 1(b)) is, for example, 0.8 nm to 10 nm, particularly 0.8 nm to 5 nm, and more particularly about 1 nm, and the total number of layers can be 2 to 20,000.

In the conductive two-dimensional particle of the present embodiment, the multilayer MXene that can be included is preferably MXene having a few layers obtained through the delamination treatment. The term “the number of layers is small” means that, for example, the number of stacked layers of MXene may be 10 layer or less, and may be 6 or less. The thickness, in the stacking direction, of the multilayer MXene having a small number of layers is preferably 15 nm or less, and further preferably 10 nm or less. Hereinafter, the “multilayer MXene having a few layers” may be referred to as a “few-layer MXene” in some cases. In addition, the single-layer MXene and the few-layer MXene may be collectively referred to as “single-layer/few-layer MXene” in some cases.

The conductive two-dimensional particle of the present embodiment preferably contains a single-layer MXene and a few-layer MXene, that is, a single-layer/few-layer MXene. In the conductive two-dimensional particle of the present embodiment, the ratio of the single-layer/few-layer MXene having a thickness of 10 nm or less is preferably 90 vol % or more, and more preferably 95 vol % or more in terms of the ratio to the total MXene.

(Li Content of Conductive Two-Dimensional Particles)

The conductive two-dimensional particle of the present embodiment has a Li content of 0.0001 mass % to 0.0020 mass %. Since the Li content is suppressed to 0.0020 mass % or less, the resistance change is reduced. In addition, the lower the Li content, the higher the conductivity of the conductive film formed using the conductive two-dimensional particles. The Li content is preferably 0.0010 mass % or less, and more preferably 0.0008 mass % or less. From the viewpoint of achieving both high conductivity and reduction in resistance change, the lower limit of the Li content is 0.0001 mass %. The Li content can be measured by, for example, ICP-AES using inductively coupled plasma emission spectrometry.

(Average Value of Major Diameters of Two-Dimensional Surfaces of Conductive Two-Dimensional Particles)

In the conductive two-dimensional particle of the present embodiment, the average value of the major diameters of the two-dimensional surfaces is 1.0 μm to 20 μm. Hereinafter, the average value of the major diameters of the two-dimensional surfaces may be referred to as “average flake size”.

The conductivity of the film increases as the average flake size increases. Since the conductive two-dimensional particle of the present embodiment has a large average flake size of 1.0 μm or more, a film formed using the conductive two-dimensional particle, for example, a film obtained by stacking the conductive two-dimensional particles can achieve conductivity of 2,000 S/cm or more. The average value of the major diameters of the two-dimensional surfaces is preferably 1.5 μm or more, and more preferably 2.5 μm or more. Non-Patent Document 1, the delamination of MXene is performed by subjecting MXene to an ultrasonic treatment, but since most of MXene is reduced in diameter to about several hundred nm in major diameter by the ultrasonic treatment, it is considered that the film formed of the single-layer MXene obtained in Non-Patent Document 1 has low conductivity.

The average value of the major diameters of the two-dimensional surfaces is 20 μm or less, preferably 15 μm or less, and more preferably 10 μm or less from the viewpoint of securing dispersibility in the solution.

As described in examples to be described later, the major diameter of the two-dimensional surface refers to a major diameter when each conductive two-dimensional particle is approximated to an elliptical shape in an electron micrograph, and the average value of the major diameters of the two-dimensional surface refers to a number average of the major diameters of 80 particles or more. As the electron microscope, a scanning electron microscope (SEM) photograph or a transmission electron microscope (TEM) photograph can be used.

The average value of the major diameters of the conductive two-dimensional particles of the present embodiment may be measured by dissolving a conductive film containing the conductive two-dimensional particles in a solvent and dispersing the conductive two-dimensional particles in the solvent. Alternatively, it may be measured from an SEM image of the conductive film.

(Average Value of Thicknesses of Conductive Two-Dimensional Particles)

The average value of the thicknesses of the conductive two-dimensional particles of the present embodiment is preferably 1 nm to 10 nm. The average value of the thicknesses is preferably 7 nm or less and more preferably 5 nm or less. On the other hand, in consideration of the thickness of the single-layer MXene, the lower limit of the average value of the thicknesses of the conductive two-dimensional particle may be 1 nm.

The average value of the thickness of the conductive two-dimensional particles is measured with a micrometer to calculate the average thickness, or measured with a stylus surface profiler to calculate the average thickness, or is determined as a number average dimension (for example, a number average of at least 40 particles) based on an atomic force microscope (AFM) photograph or a transmission electron microscope (TEM) photograph.

(Interlayer Distance of Conductive Two-Dimensional Particles)

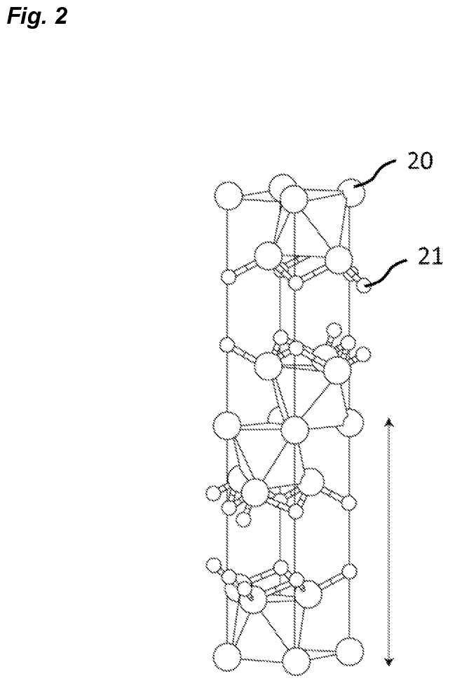

In the conductive two-dimensional particle of the present embodiment, since Li ions hardly exist between the layers constituting MXene, a distance between the layers constituting MXene, for example, a distance between the layers indicated by double-headed arrows in FIG. 2 is short in Ti₃C₂O₂ which is an example of MXene in which MₘXₙ is represented by Ti₃C₂. The distance can be determined by the position of a low-angle peak of 10° or less corresponding to the (002) plane of MXene in an XRD profile obtained by X-ray diffraction measurement. The higher the peak in the XRD profile is, the narrower the interlayer distance is. In the conductive two-dimensional particle in the present embodiment, the peak of the (002) plane obtained by X-ray diffraction measurement is preferably 8.0° or more. The peak is more preferably 8.5° or more. The upper limit of the peak position is about 9.0°. The peak refers to a peak top. The X-ray diffraction measurement may be performed under the conditions shown in examples described later. The object to be measured may be conductive two-dimensional particles (MXene particles), or may be a conductive film (MXene film) formed of conductive two-dimensional particles (MXene particles).

In the conductive two-dimensional particle of the present embodiment, a conductive film is formed of the conductive two-dimensional particles, and the conductivity obtained by substituting a thickness of the conductive film measured with a micrometer, a scanning electron microscope (SEM), or a stylus surface profiler and a surface resistivity of the conductive film measured by a four-point probe method into the following formula: Conductivity [S/cm]=1/(thickness [cm] of conductive film×surface resistivity [Q/sq.] of conductive film) can achieve 2,000 S/cm or more.

The conductive film is formed as follows. That is, a supernatant or clay obtained after treatment with an acid solution and washing with water is subjected to suction filtration according to the production conditions of a conductive film using conductive two-dimensional particles of example 1 described later. After the filtration, vacuum drying is performed at 80° C. for 24 hours to prepare a conductive film (MXene film). As a filter for suction filtration, a membrane filter (Durapore, manufactured by Merck KGaA, pore size 0.45 μm) is used. The supernatant contains 0.05 g of solid content of MXene particles and 40 mL of pure water.

The thickness of the conductive film is measured by any one of a micrometer, a scanning electron microscope, and a stylus surface profiler. Which measurement method is adopted is determined according to the thickness of the conductive film. As an indication of adoption of the measurement method, the measurement with the micrometer may be used when the thickness of the conductive film is thin. The measurement may be used when the thickness of the conductive film is 5 μm or more. The measurement with the stylus surface profiler is used when the thickness of the conductive film is 400 μm or less, and the measurement with the scanning electron microscope is used when the thickness of the conductive film is 200 μm or less and cannot be measured with the stylus surface profiler. In the case of measurement with the scanning electron microscope, the measurement magnification is as shown in Table 1 below depending on the film thickness. If measured with a stylus surface profiler, the measurement is made with a Dektak (registered trademark) instrument from Veeco Instruments Inc. The thickness of the conductive film is calculated as an average value.

TABLE 1

| | Measurement |
|---|---|
| | magnification |
| Film thickness (μm) | (times) |
| 100 ≤ film thickness ≤ 200 | 500 |
| 50 ≤ film thickness < 100 | 1000 |
| 10 ≤ film thickness < 50 | 2000 |
| 5 ≤ film thickness < 10 | 10000 |
| 1 ≤ film thickness < 5 | 30000 |
| Film thickness < 1 | 50000 |

The conductive two-dimensional particle of the present embodiment does not contain an amine. When the delamination of MXene is performed using TMAOH as disclosed in Non-Patent Document 2, the single-layer/few-layer MXene is obtained, but TMAOH remains on the surface of MXene even after washing, and the conductivity decreases due to this, which is not preferable. The phrase “does not contain an amine” in the present specification means that triethylamine derived from TMAOH (m/z=42, 53, 54) is 10 ppm by mass or less as measured using a gas chromatography mass spectrometer (GCMS).

The conductive two-dimensional particles of the present embodiment may have a total content of chlorine and bromine of 1,500 ppm by mass or less or more than 1,500 ppm by mass, and the total content of chlorine and bromine may be more than 1,500 ppm by mass depending on the production conditions.

### Second Embodiment: Method for Producing Conductive Two-Dimensional Particle

Hereinafter, a method for producing a conductive two-dimensional particle in the embodiment of the present invention will be described in detail, but the present invention is not limited to such an embodiment.

A method for producing a conductive two-dimensional particle according to the present embodiment (first production method) includes:

(a) preparing a precursor, the precursor represented by a formula below:

MₘAXₙ

wherein M is at least one metal of Group 3, 4, 5, 6, or 7,

X is a carbon atom, a nitrogen atom, or a combination thereof,

A is at least one element of Group 12, 13, 14, 15, or 16,

n is 1 to 4, and

m is more than n and 5 or less;

(b1) performing an etching treatment of removing at least a part of A atoms from the precursor by using an etching solution;

(c) performing Li intercalation treatment including a step of mixing and stirring an etched product obtained by the etching treatment and a Li-containing compound;

(d) performing a delamination treatment, including a step of centrifuging a Li intercalated product obtained by the Li intercalation treatment, discarding a supernatant, and then washing a remaining precipitate with water;

(e) performing an acid treatment, including a step of mixing and stirring a delaminated product obtained by the delamination treatment and an acid solution; and

(f) washing an acid-treated product obtained by the acid treatment with water to obtain a conductive two-dimensional particle. By this production method, it is possible to produce conductive two-dimensional particles having a Li content of 0.0020 mass % or less in the conductive two-dimensional particles.

Another method for producing a conductive two-dimensional particle according to the present embodiment (second production method) includes:

(a) preparing a precursor, the precursor represented by a formula below:

MₘAXₙ

wherein M is at least one metal of Group 3, 4, 5, 6, or 7,

X is a carbon atom, a nitrogen atom, or a combination thereof,

A is at least one element of Group 12, 13, 14, 15, or 16,

n is 1 to 4, and

m is more than n and 5 or less;

(b2) etching at least a part of A atoms from the precursor and performing a Li intercalation treatment, by using an etching solution containing Li-containing compound;

(d) performing a delamination treatment, including a step of centrifuging the (etched+Li intercalated) product obtained by the etching and Li intercalation treatment, discarding a supernatant, and then washing a remaining precipitate with water;

(e) performing an acid treatment, including a step of mixing and stirring a delaminated product obtained by the delamination treatment and an acid solution; and

(f) washing an acid-treated product obtained by the acid treatment with water to obtain a conductive two-dimensional particle. By this production method, it is possible to produce conductive two-dimensional particles having a Li content of 0.0020 mass % or less in the conductive two-dimensional particles.

Hereinafter, each step of the first production method and the second production method will be described in detail. The step (a) and the steps (d) to (f) common to these two production methods will be collectively described.

Step (a)

First, a predetermined precursor is prepared. A predetermined precursor that can be used in the present embodiment is a MAX phase that is a precursor of MXene, and is represented by a formula below:

MₘAXₙ

wherein M is at least one metal of Group 3, 4, 5, 6, or 7,

X is a carbon atom, a nitrogen atom, or a combination thereof,

A is at least one element of Group 12, 13, 14, 15, or 16,

n is 1 to 4, and

m is more than n and 5 or less.

The above M, X, n, and m are as described in MXene. A is at least one element of Group 12, 13, 14, 15, or 16, is usually a Group A element, typically Group IIIA and Group IVA, more specifically, may include at least one selected from the group consisting of Al, Ga, In, Tl, Si, Ge, Sn, Pb, P, As, S, or Cd, and is preferably Al.

The MAX phase has a crystal structure in which a layer constituted by A atoms is located between two layers represented by MₘXₙ (each X may have a crystal lattice located in an octahedral array of M). Typically, in the case of m=n+1, the MAX phase has a repeating unit in which one layer of X atoms is disposed between the layers of M atoms of n+1 layers (these layers are also collectively referred to as “MₘXₙ layer”), and a layer of A atoms (“A atom layer”) is disposed as a next layer of the (n+1) th layer of M atoms; however, the present invention is not limited thereto.

The MAX phase can be produced by a known method. For example, a TiC powder, a Ti powder, and an Al powder are mixed in a ball mill, and the obtained mixed powder is fired under an Ar atmosphere to obtain a fired body (block-shaped MAX phase). Thereafter, the fired body obtained is pulverized by an end mill to obtain a powdery MAX phase for the next step.

Step (b1)

In the first production method, an etching treatment is performed to remove at least a part of A atoms from the precursor using an etching solution. The etching treatment is not particularly limited, and known conditions can be adopted. As described above, the etching can be performed using an etching solution containing F⁻, and examples thereof include a method using hydrofluoric acid, a method using a mixed liquid of lithium fluoride and hydrochloric acid, and a method using an etching solution further containing phosphoric acid or the like. Examples of these methods include a method using a mixed liquid with pure water as a solvent. Examples of the etched product obtained by the etching treatment include slurry.

Step (c)

A Li intercalation treatment is performed, which includes a step of mixing and stirring the etched product obtained by the etching treatment and the Li-containing compound.

Examples of the Li-containing compound include metal compounds containing Li ions. As a metal compound containing Li ions, an ionic compound in which a Li ion and a cation are bonded can be used. Examples of the Li ionic compound include an iodide, a phosphate, a sulfide salt including a sulfate, a nitrate, an acetate, and a carboxylate.

The content of the Li-containing compound in a formulation for intercalation treatment is preferably 0.001 mass % or more. The content is more preferably 0.01 mass % or more, and still more preferably 0.1 mass % or more. On the other hand, from the viewpoint of dispersibility in a solution, the content of the Li-containing compound is preferably 10 mass % or less, and more preferably 1 mass % or less.

In the step (c), for example, a moisture medium clay of MXene, as an etched product, obtained by washing the slurry obtained by the etching treatment in the step (b1) by repeating centrifugation, removal of the supernatant, addition of pure water to the remaining precipitate, and centrifugation again may be subjected to the intercalation treatment.

The specific method of the intercalation treatment is not particularly limited, and examples thereof include mixing a Li-containing compound with the moisture medium clay of MXene and stirring the mixture at room temperature.

In the second production method, as described below, the etching treatment of the precursor and the Li intercalation treatment are performed together in step (b2).

Step (b2)

In the second production method, at least a part of A atoms (and a part of M atoms in some cases) are etched (removed and separated into layers in some cases) from the precursor and the Li intercalation treatment is performed, by using an etching solution containing a Li-containing compound.

In the present embodiment, the Li intercalation treatment is performed in which Li ions are inserted between the layers of the MₘXₙ layer at the time of etching (removal and layer separation in some cases) of at least a part of A atoms (and a part of the M atoms in some cases) from the MAX phase.

The content of the Li-containing compound in the etching solution is preferably 0.001 mass % or more. The content is more preferably 0.01 mass % or more, and still more preferably 0.1 mass % or more. On the other hand, from the viewpoint of dispersibility in a solution, the content of the Li-containing compound in the etching solution is preferably 10 mass % or less, and more preferably 1 mass % or less.

The etching solution in the step (b2) contains a Li-containing compound, and other configurations of the etching solution are not particularly limited, and known conditions can be adopted. For example, as described in the step (b1), the etching can be performed using an etching solution further containing F⁻, and examples thereof include a method using hydrofluoric acid, a method using a mixed liquid of lithium fluoride and hydrochloric acid, and a method using an etching solution further containing phosphoric acid or the like. Examples of these methods include a method using a mixed liquid with pure water as a solvent. Examples of the etched product obtained by the etching treatment include slurry.

Among the first production method and the second production method, according to a production method in which the step (b1) of etching treatment and the step (c) of Li intercalation treatment are separated as in the first production method, MXene is more easily formed into a single layer, which is preferable.

Step (d)

A Li intercalated product obtained by the Li intercalation treatment in the first production method or a (etched+Li intercalated) product obtained by the etching and the Li intercalation treatment in the second production method is subjected to a delamination treatment including a step of centrifuging, discarding the supernatant, and then washing the remaining precipitate with water. The conditions for delamination treatment are not particularly limited, and delamination can be performed by a known method. Examples of the method include the following method.

For example, a slurry-like Li intercalated product or a (etched+Li intercalated) product is centrifuged to discard the supernatant, and then the remaining precipitate is washed with water. More specifically, in the step (i), pure water is added to the remaining precipitate after discarding the supernatant, and the mixture is stirred, (ii) centrifuged, and (iii) the supernatant is recovered. This operation of (i) to (iii) is repeated 1 time or more, preferably 2 times to 10 times to obtain a single-layer/few-layer MXene-containing supernatant before an acid treatment as a delaminated product. Alternatively, the supernatant may be centrifuged, the supernatant after centrifugation may be discarded, and a single-layer/few-layer MXene-containing clay before the acid treatment may be obtained as a delaminated product.

Step (e)

An acid treatment is performed, which includes a step of mixing and stirring the delaminated product (single-layer/few-layer MXene-containing supernatant or single-layer/few-layer MXene-containing clay) obtained by the delamination treatment and an acid solution. The acid used for the acid treatment is not limited, and for example, an inorganic acid such as a mineral acid and/or an organic acid can be used. The acid is preferably only an inorganic acid or a mixed acid of an inorganic acid and an organic acid. The acid is more preferably only an inorganic acid. As the inorganic acid, for example, one or more of hydrochloric acid, sulfuric acid, nitric acid, phosphoric acid, perchloric acid, hydroiodic acid, hydrobromic acid, hydrofluoric acid, and the like can be used. It is preferably one or more of hydrochloric acid and sulfuric acid. Examples of the organic acid include acetic acid, citric acid, oxalic acid, benzoic acid, and sorbic acid. The concentration of the acid solution to be mixed with the delaminated product may be adjusted according to the amount, concentration, and the like of the delaminated product to be treated.

The delaminated product and the acid solution are mixed and stirred. Examples of the stirring method include stirring using a handshake, an automatic shaker, a share mixer, a pot mill, or the like. The degree of stirring such as stirring speed and stirring time may be adjusted according to the amount, concentration, and the like of the delaminated product which is an object to be treated.

When the acid solution is mixed and stirred, heating may or may not be performed. The acid solution may be mixed and stirred without being heated, or may be stirred while being heated in a range in which the liquid temperature is 80° C. or lower.

After the stirring, for example, centrifugation is performed to remove the supernatant, and an acid-treated product can be obtained as a slurry. The operation of mixing and stirring with the acid solution may be performed one or more times. From the viewpoint of further reducing the Li content in the MXene particles, it is preferable to perform the operation of mixing with the acid solution and stirring the mixture 2 times or more, for example, 10 times or less. As an aspect in which the operation of mixing and stirring with the acid solution is performed a plurality of times, steps (i) to (iii) of (i) mixing and stirring the acid solution (and the delaminated product or the remaining precipitate obtained in the following (iii)), (ii) centrifuging the stirred product, and (iii) discarding the supernatant after centrifugation are performed within a range of 2 times or more, for example, 10 times or less.

The pH of the acid-treated product obtained by the acid treatment is preferably 2.5 or less. The pH is more preferably 2.0 or less, still more preferably 1.5 or less, and even still more preferably 1.2 or less. The lower limit of the pH is not particularly limited, and is about 1.0. When the pH of the acid-treated product is sufficiently low as described above, the dispersibility of the MXene particles is reduced, and the MXene particles are difficult to handle in the subsequent step. However, according to the present embodiment, unlike Non-Patent Document 1, the problem is solved by performing washing with water in the next step.

In the present invention, unlike Non-Patent Document 1, since Li is actively removed by performing the acid treatment as described above, the Li content in the MXene particles can be further reduced.

Step (f)

The acid-treated product obtained by the acid treatment is washed with water to obtain conductive two-dimensional particles. The amount of water mixed with the acid-treated product and the washing method are not particularly limited. For example, stirring after adding water, centrifugation, and the like may be performed. Examples of the stirring method include stirring using a handshake, an automatic shaker, a share mixer, a pot mill, or the like. The degree of stirring such as stirring speed and stirring time may be adjusted according to the amount, concentration, and the like of the acid-treated product which is an object to be treated. The washing with water may be performed one or more times. Preferably, washing with water is performed a plurality of times. For example, specifically, steps (i) to (iii) of (i) adding water and stirring (to the acid-treated product or the remaining precipitate obtained in the following (iii)), (ii) centrifuging the stirred product, and (iii) discarding the supernatant after centrifugation are performed within a range of 2 times or more, for example, 10 times or less.

After the acid-treated product is washed with water, the pH is preferably 4 or more, for example, 7 or less. According to the present embodiment, for example, the pH is increased to 4 or more by washing with water, whereby the dispersibility of the MXene particles described above can be secured, and for example, a conductive film can be easily formed.

In the production method of the present embodiment, an ultrasonic treatment is not performed as delamination after etching. As described above, since the ultrasonic treatment is not performed, particle breakage hardly occurs, and it is possible to obtain a conductive two-dimensional particle including single-layer/few-layer MXene having a large two-dimensional surface. The conductive two-dimensional particle containing single-layer/few-layer MXene having a large two-dimensional surface can form a film without using a binder, and the obtained film exhibits high conductivity.

### Third Embodiment: Conductive Film

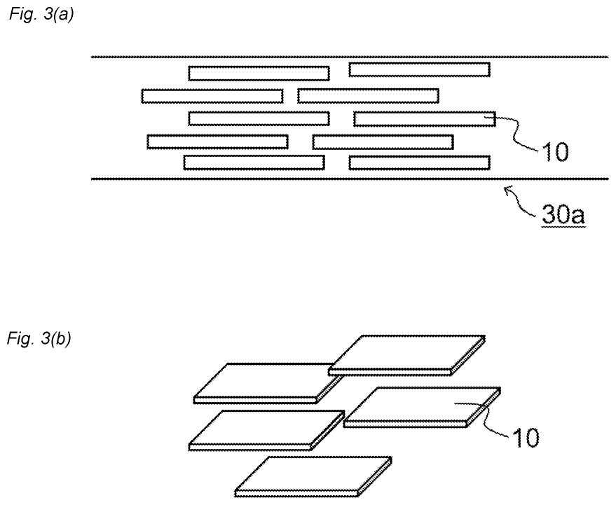

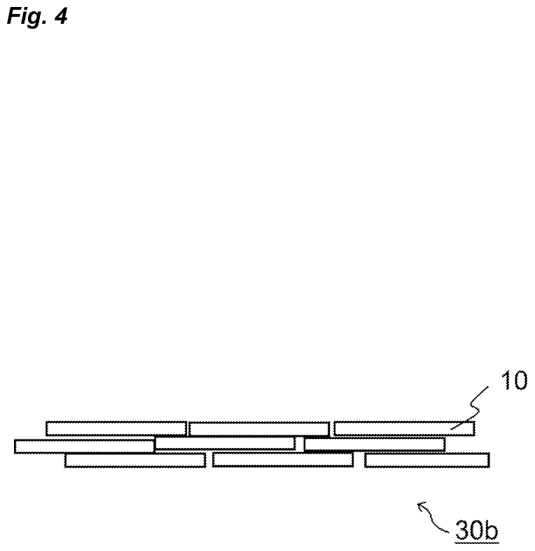

Examples of the conductive film of the present embodiment include a conductive film containing conductive two-dimensional particles of the present embodiment. Referring to FIG. 3, a conductive film 30a of the present embodiment includes conductive two-dimensional particles 10 of a predetermined layered material as illustrated in FIG. 3(a). FIG. 3(b) is a schematic perspective view of MXene particles contained in the conductive film 30a. Referring to FIG. 4, another conductive film 30b of the present embodiment will be described. FIG. 4 illustrates the conductive film 30b obtained by stacking only the conductive two-dimensional particles 10. The conductive film of the present embodiment is not limited thereto.

The conductive film may be a conductive composite material film further containing a polymer (resin). The polymer may be contained, for example, as an additive such as a binder added at the time of film formation, or may be added for providing strength or flexibility. In a case of the conductive composite material film, the proportion of the polymer in the conductive composite material film (when dried) may be more than 0 vol % and preferably 30 vol % or less. The ratio of the polymer may be further 10 vol % or less, and further 5 vol % or less. In other words, the proportion of the conductive two-dimensional particles (particles of the layered material) in the conductive composite material film (when dried) is preferably 70 vol % or more, more preferably 90 vol % or more, and still more preferably 95 vol % or more. The conductive film may be a stacked film of two or more conductive composite material films having different proportions of the conductive two-dimensional particles.

Examples of the polymer include a hydrophilic polymer (hydrophilicity is exhibited by mixing a hydrophilic auxiliary agent in a hydrophobic polymer, and a hydrophilization treatment of a surface of a hydrophobic polymer or the like is included), and the hydrophilic polymer more preferably includes one or more selected from the group consisting of polysulfone, cellulose acetate, regenerated cellulose, polyether sulfone, water-soluble polyurethane, polyvinyl alcohol, sodium alginate, an acrylic acid-based water-soluble polymer, polyacrylamide, polyaniline sulfonic acid, or nylon.

Examples of the hydrophilic polymer include a hydrophilic polymer having a polar group, and those in which the polar group is a group that forms a hydrogen bond with a modifier or terminal T of the layer are more preferable. As the polymer, for example, one or more polymers selected from the group consisting of water-soluble polyurethane, polyvinyl alcohol, sodium alginate, an acrylic acid-based water-soluble polymer, polyacrylamide, polyaniline sulfonic acid, or nylon are preferably used.

Among these, one or more polymers selected from the group consisting of water-soluble polyurethane, polyvinyl alcohol, or sodium alginate are more preferable. As the polymer, a polymer having a urethane bond having both the hydrogen bond donor property and the hydrogen bond acceptor property is preferable, and from this viewpoint, the water-soluble polyurethane is particularly preferable.

The film thickness of the conductive film is preferably 0.5 μm to 20 μm. By increasing the film thickness of the conductive film, the contact resistance of the grain boundary is reduced, and the conductivity tends to be increased, and thus the film thickness is preferably 0.5 μm or more. The film thickness is more preferably 1.0 μm or more. The film thickness is preferably as large as possible from the viewpoint of conductivity, but when flexibility or the like is required, the film thickness is preferably 20 μm or less, and more preferably 15 μm or less. The film thicknesses of the conductive film can be measured by, for example, measurement with a micrometer, cross-sectional observation by a method such as a scanning electron microscope (SEM), a microscope, or a laser microscope.

The conductive film of the present embodiment preferably maintains a conductivity of 2,000 S/cm or more, for example, when the conductive film has a sheet shape formed of the conductive two-dimensional particles and having a film thickness of 5 μm. The conductivity can be maintained as conductivity of more preferably 2,500 S/cm or more and still more preferably 3,000 S/cm or more. The conductivity of the conductive film is not particularly limited, and may be, for example, 10,000 S/cm or less. The conductivity can be determined as follows. That is, the surface resistivity is measured by a four-point probe method, a value obtained by multiplying the thickness [cm] by the surface resistivity [Ω/sq.] is the volume resistivity [Ω·cm], and the conductivity [S/cm] can be obtained as the reciprocal thereof.

(Method for Producing Conductive Film)

A method for producing a conductive film of the present embodiment using MXene particles (conductive two-dimensional particles) produced as described above is not particularly limited. For example, as exemplified below, a conductive film can be formed.

First, an MXene dispersion in which the MXene particles prepared as described above are present in a medium liquid is prepared. Examples of the medium liquid include an aqueous medium liquid and an organic medium liquid. The medium liquid of the MXene dispersion is typically water, and in some cases, other liquid substances may be contained in a relatively small amount (for example, 30 mass % or less, preferably 20 mass % or less based on the whole mass) in addition to water.

Before drying, a precursor of a conductive film (also referred to as a “precursor film”) may be formed using the MXene dispersion. The method for forming the precursor film is not particularly limited, and for example, suction filtration, coating, spray, or the like can be used.

More specifically, as the MXene dispersion, for example, a supernatant containing conductive two-dimensional particles is appropriately adjusted (for example, diluted with an aqueous medium liquid), and is subjected to suction filtration through a filter (which may constitute a predetermined member together with the conductive film, or may be finally separated from the conductive film) installed in a nutsche or the like. Thereby, the aqueous medium liquid is at least partially removed, so that a precursor can be formed on the filter. The filter is not particularly limited, but a membrane filter or the like can be used. By performing the suction filtration, a conductive film can be produced without using the binder or the like. When the conductive two-dimensional particles of the present embodiment are used, a conductive film can be produced without using a binder or the like as described above.

Alternatively, the MXene dispersion may be applied to the substrate as it is or after being appropriately adjusted (for example, dilution with an aqueous medium liquid, or addition of a binder). Examples of the coating method include a spray coating method in which spray coating is performed using a nozzle such as a one-fluid nozzle, a two-fluid nozzle, or an air brush, a slit coating method using a table coater, a comma coater, or a bar coater, a screen printing method, a metal mask printing method, a spin coating, dip coating, or dropping. As a substrate, for example, a substrate formed of a metal material, a resin, or the like suitable for the biosignal sensing electrode can be appropriately adopted as the substrate. By coating onto any suitable substrate (which may constitute a predetermined member together with the conductive film, or may be finally separated from the conductive film), a precursor film can be formed on the substrate.

Next, the precursor film formed as described above is dried to obtain, for example, a conductive film 30 as schematically illustrated in FIG. 4. In the present invention, the “drying” means removing the aqueous medium liquid that can exist in the precursor.

Drying may be performed under mild conditions such as natural drying (typically, it is disposed in an air atmosphere at normal temperature and normal pressure.) or air drying (blowing air), or may be performed under relatively active conditions such as hot air drying (blowing heated air), heat drying, and/or vacuum drying. The drying may be performed, for example, at a temperature of 400° C. or lower using a normal pressure oven or a vacuum oven.

The forming and drying the precursor film may be appropriately repeated until a desired conductive film thickness is obtained. For example, a combination of spraying and drying may be repeated a plurality of times.

When the conductive composite material of the present embodiment has a sheet-like form, for example, as illustrated below, the conductive two-dimensional particles and the polymer can be mixed to form a coating film.

First, the MXene dispersion or the MXene powder in which the conductive two-dimensional particles (MXene particles) are present in a medium liquid (aqueous medium liquid or organic medium liquid) may be mixed with a polymer. The medium liquid of the MXene dispersion is typically water, and in some cases, other liquid substances may be contained in a relatively small amount (for example, 30 mass % or less, preferably 20 mass % or less based on the whole mass) in addition to water.

The stirring of the conductive two-dimensional particles (MXene particles) and the polymer can be performed using a dispersing device such as a homogenizer, a propeller stirrer, a thin film swirling stirrer, a planetary mixer, a mechanical shaker, or a vortex mixer.

A slurry which is a mixture of the MXene particles and the polymer may be applied to a substrate (for example, a substrate), but the application method is not limited. Examples of the coating method include a spray coating method in which spray coating is performed using a nozzle such as a one-fluid nozzle, a two-fluid nozzle, or an air brush, a slit coating method using a table coater, a comma coater, or a bar coater, a screen printing method, a metal mask printing method, a spin coating, dip coating, or dropping. As described above, a substrate formed of a metal material, a resin, or the like suitable for the biosignal sensing electrode can be appropriately adopted as the substrate.

The coating and drying may be repeated a plurality of times as necessary until a film having a desired thickness is obtained. The drying and curing may be performed, for example, at a temperature of 400° C. or lower using a normal pressure oven or a vacuum oven.

### Fourth Embodiment: Conductive Paste

Examples of other applications of using the conductive two-dimensional particles of the present embodiment include a conductive paste containing the conductive two-dimensional particles. Examples of the conductive paste include a mixture of conductive two-dimensional particles (particles of a predetermined layered material) and a medium. Examples of the medium include an aqueous medium liquid, an organic medium liquid, a polymer, metal particles, and ceramic particles, and examples thereof include those containing one or more of these. The mass ratio of the conductive two-dimensional particles (particles of the layered material) in the conductive paste is, for example, 50% or more.

Examples of the application include forming a conductive film by applying the conductive paste onto a substrate or the like and drying the paste.

### Fifth Embodiment: Conductive Composite Material

Examples of other applications of using the conductive two-dimensional particles of the present embodiment include a conductive composite material containing the conductive two-dimensional particles and a polymer. The conductive composite material is not limited to the shape of the conductive composite material film (conductive composite material film) described above. The shape of the conductive composite material may be a shape having thickness, a rectangular parallelepiped, a sphere, a polygon, or the like, other than the film shape.

As the polymer, a polymer similar to the polymer used for the conductive composite material film (conductive composite material film) can be used. For example, it may be contained as an additive such as a binder added at the time of film formation, or may be added for providing strength or flexibility. The proportion of the polymer in the conductive composite material (when dried) may be more than 0 vol % and preferably 30 vol % or less. The ratio of the polymer may be further 10 vol % or less, and further 5 vol % or less. In other words, the proportion of the particles of the layered material in the conductive composite material (when dried) is preferably 70 vol % or more, more preferably 90 vol % or more, and still more preferably 95 vol % or more.

Examples of the polymer include a hydrophilic polymer (hydrophilicity is exhibited by mixing a hydrophilic auxiliary agent in a hydrophobic polymer, and a hydrophilization treatment of a surface of a hydrophobic polymer or the like is included), and the hydrophilic polymer more preferably includes one or more selected from the group consisting of polysulfone, cellulose acetate, regenerated cellulose, polyether sulfone, water-soluble polyurethane, polyvinyl alcohol, sodium alginate, an acrylic acid-based water-soluble polymer, polyacrylamide, polyaniline sulfonic acid, or nylon.

Examples of the hydrophilic polymer include a hydrophilic polymer having a polar group, and those in which the polar group is a group that forms a hydrogen bond with a modifier or terminal T of the layer are more preferable. As the polymer, for example, one or more polymers selected from the group consisting of water-soluble polyurethane, polyvinyl alcohol, sodium alginate, an acrylic acid-based water-soluble polymer, polyacrylamide, polyaniline sulfonic acid, or nylon are preferably used.

Among these, one or more polymers selected from the group consisting of water-soluble polyurethane, polyvinyl alcohol, or sodium alginate are more preferable. As the polymer, a polymer having a urethane bond having both the hydrogen bond donor property and the hydrogen bond acceptor property is preferable, and from this viewpoint, the water-soluble polyurethane is particularly preferable.

Although the conductive two-dimensional particles, the method for producing the conductive two-dimensional particles, the conductive film, the conductive paste, and the conductive composite material in the embodiments of the present invention have been described in detail above, various modifications are possible. It should be noted that the conductive two-dimensional particle according to the present invention may be produced by a method different from the production method in the above-described embodiment, and the method for producing a conductive two-dimensional particle of the present invention is not limited only to one that provides the conductive two-dimensional particle according to the above-described embodiment.

### EXAMPLES

[Preparation of Single-Layer MXene]

### Examples 1 to 4

In examples 1 to 4, steps of (1) preparation of the precursor (MAX), (2) etching of the precursor, (3) washing after etching, (4) intercalation of Li, (5) delamination, (6) acid treatment, and (7) washing with water described below in detail were performed in this order to prepare a single-layer/few-layer MXene-containing sample.

(1) Preparation of Precursor (MAX)

TiC powder, Ti powder, and Al powder (all manufactured by Kojundo Chemical Laboratory Co., Ltd.) were placed in a ball mill containing zirconia balls at a molar ratio of 2:1:1 and mixed for 24 hours. The obtained mixed powder was fired at 1350° C. for 2 hours under an Ar atmosphere. The fired body (block-shaped MAX) thus obtained was pulverized with an end mill to a maximum dimension of 40 μm or less. In this way, Ti₃AlC₂ particles were obtained as a precursor (powdery MAX).

(2) Etching of Precursor

Using the Ti₃AlC₂ particles (powder) prepared by the above method, etching was performed under the following etching conditions to obtain a solid-liquid mixture (slurry) containing a solid component derived from the Ti₃AlC₂ powder.

(Etching Conditions)

Precursor: Ti₃AlC₂ (sieving with a mesh size of 45 μm)

Etching solution composition: 49% HF 6 mL

H₂O 18 mL

HCl (12M) 36 mL

Amount of precursor input: 3.0 g

Etching container: 100 mL Aiboy

Etching temperature: 35° C.

Etching time: 24 h

Stirrer rotation speed: 400 rpm

(3) Washing after Etching

The slurry was divided into two portions, each of which was inserted into two 50 mL centrifuge tubes, centrifuged under the condition of 3500 G using a centrifuge, and then the supernatant was discarded. An operation of adding 40 mL of pure water to the remaining precipitate in each centrifuge tube, centrifuging again at 3500 G, and separating and removing the supernatant was repeated 11 times. After final centrifugation, the supernatant was discarded to obtain a Ti₃C₂Tₛ-moisture medium clay.

(4) Intercalation of Li

The Ti₃C₂Tₛ-moisture medium clay prepared by the above method was stirred at 20° C. or higher and 25° C. or lower for 12 hours using LiCl as a Li-containing compound according to the following conditions to perform intercalation of Li.

(Conditions of Intercalation of Li)

Ti₃C₂Tₛ-moisture medium clay (MXene after washing): Solid content 0.75 g

LiCl: 0.75 g

Intercalation container: 100 mL Aiboy

Temperature: 20° C. or higher and 25° C. or lower (room temperature)

Time: 12 h

Stirrer rotation speed: 800 rpm

(5) Delamination

The slurry obtained by Li intercalation was charged into a 50 mL centrifuge tube, centrifuged under the condition of 3500 G using a centrifuge, and then the supernatant was discarded. Next, (i) 40 mL of pure water was added to the remaining precipitate, and the mixture was stirred for 15 minutes with a shaker, then (ii) centrifuged at 3500 G, and (iii) the supernatant was recovered as a single-layer/few-layer MXene-containing liquid. The operations (i) to (iii) were repeated 4 times in total to obtain a single-layer/few-layer MXene-containing supernatant. Further, this supernatant was centrifuged under the conditions of 4300 G and 2 hours using a centrifuge, and then the supernatant was discarded to obtain a single-layer/few-layer MXene-containing clay.

(6) Acid Treatment

(i) 35 mL of 1.8 M hydrochloric acid was added to the single-layer/few-layer MXene-containing clay, then the mixture was stirred with a shaker for 5 minutes, then (ii) centrifuged at 3500 G, and (iii) the supernatant was discarded. The operations (i) to (iii) were repeated 5 times in total.

(7) Water Washing

(i) 35 mL of water was added to the single-layer/few-layer MXene-containing clay after acid treatment, then the mixture was stirred with a shaker for 5 minutes, then (ii) centrifuged at 3500 G, and (iii) the supernatant was discarded. The operations (i) to (iii) were repeated 5 times in total to obtain a single-layer/few-layer MXene-containing clay as a single-layer/few-layer MXene-containing sample. It was confirmed that the pH of the supernatant was finally 4 or more.

### Comparative Examples 1 and 2

In comparative examples 1 and 2, (1) the precursor (MAX) was prepared in the same manner as in examples 1 to 4, and then the following steps (2) to (5) were sequentially performed with reference to the method described in Non-Patent Document 1 to obtain a single-layer/few-layer MXene-containing sample.

(1) Preparation of Precursor (MAX): Same as in Examples 1 to 4

(2) Etching of Precursor

Using the Ti₃AlC₂ particles (powder) prepared by the above method, etching was performed under the following etching conditions to obtain a solid-liquid mixture (slurry) containing a solid component derived from the Ti₃AlC₂ powder.

Precursor: Ti₃AlC₂ (sieving with a mesh size of 45 μm)

Etching solution composition: LiF 2.4 g

HCl (9M) 30 mL

Amount of precursor input: 1.5 g

Etching container: 100 mL Aiboy

Etching temperature: 25° C.

Etching time: 36 h

Stirrer rotation speed: 400 rpm

(3) Washing after Etching

The slurry was inserted into a 50 mL centrifuge tube, centrifuged under the condition of 3500 G using a centrifuge, and then the supernatant was discarded. (i) 40 mL of pure water was added to the remaining precipitate in each centrifuge tube and (ii) centrifuged again at 3500 G to (iii) separate and remove the supernatant. The operations (i) to (iii) were repeated 10 times in total, it was confirmed that the pH of the 10th supernatant was more than 5, and the supernatant was discarded to obtain a Ti₃C₂Tₛ-moisture medium clay.

(4) Delamination

200 mL of pure water was added to the Ti₃C₂Tₛ-moisture medium clay, and ultrasonic treatment was performed at 10° C. or lower for 15 minutes in an ultrasonic bath (Ultrasonic cleaner (ASU series), product number 1-2160-03). Thereafter, the mixture was centrifuged at 2000 G for 20 minutes using a centrifuge, and then the supernatant was recovered.

(5) pH Adjustment

In comparative example 1, 1 mL of 6.0 M hydrochloric acid was added dropwise to 59.0 mL of the supernatant, and in comparative example 2, 0.8 mL of 6.0 M hydrochloric acid was added dropwise to 59.2 mL of the supernatant. Thereafter, in the same manner as in the delamination described in (4) above, the ultrasonic treatment was performed at 10° C. or lower for 10 minutes in an ultrasonic bath to obtain a single-layer/few-layer MXene-containing clay as a single-layer/few-layer MXene-containing sample.

### Comparative Example 3

In comparative example 3, (1) the precursor (MAX) was prepared in the same manner as in examples 1 to 4 described above, and then the following steps (2) to (6) were sequentially performed with reference to the method described in Non-Patent Document 2 to obtain a single-layer/few-layer MXene-containing sample.

(1) Preparation of Precursor (MAX): Same as in Examples 1 to 4

(2) Etching of Precursor

Using the Ti₃AlC₂ particles (powder) prepared by the above method, etching was performed under the following etching conditions to obtain a solid-liquid mixture (slurry) containing a solid component derived from the Ti₃AlC₂ powder.

(Etching Conditions)

Precursor: Ti₃AlC₂ (sieving with a mesh size of 45 μm)

Etching solution composition: 49% HF 6 mL

H₂O 54 mL

Amount of precursor input: 3.0 g

Etching container: 100 mL Aiboy

Etching temperature: 20° C. or higher and 25° C. or lower (room temperature)

Etching time: 24 h

Stirrer rotation speed: 400 rpm

(3) Washing after Etching

The slurry was divided into two portions, each of which was inserted into two 50 mL centrifuge tubes, centrifuged under the condition of 3500 G using a centrifuge, and then the supernatant was discarded. (i) 40 mL of pure water was added to the remaining residue in each centrifuge tube and (ii) centrifuged again at 3500 G to (iii) separate and remove the supernatant. The operations (i) to (iii) were repeated 11 times in total. After final centrifugation, the supernatant was discarded to obtain a Ti₃C₂Tₛ-moisture medium clay as a remaining precipitate.

(4) Intercalation of TMAOH

With respect to Ti₃C₂Tₛ-moisture medium clay prepared by the above method, in accordance with the following conditions, the mixture was stirred at 20° C. or higher and 25° C. or lower for 12 hours to perform the intercalation of the TMAOH by using the TMAOH as an intercalator.

(Conditions of Intercalation of TMAOH)

Ti₃C₂Tₛ-moisture medium clay (MXene after washing): Solid content 1.0 g

TMAOH·5H₂O: 1.98 g

Pure water: 100 mL

Intercalation container: 250 mL Aiboy

Temperature: 20° C. or higher and 25° C. or lower (room temperature)

Time: 12 h

Stirrer rotation speed: 800 rpm

(5) Delamination

The slurry obtained by intercalation of TMAOH was divided into two portions, and inserted into two 50 mL centrifuge tubes, respectively, and centrifuged under the condition of 3500 G using a centrifuge to recover a supernatant. (i) 40 mL of pure water was added to the remaining precipitate in each centrifuge tube and (ii) centrifuged again at 3500 G to (iii) recover the supernatant. The operations (i) to (iii) were repeated 2 times in total to obtain a single-layer/few-layer MXene-containing supernatant.

(6) Recovery of Single-Layer/Few-Layer MXene-Containing Clay

The single-layer/few-layer MXene-containing supernatant was centrifuged at 3500 G for 1 hour using a centrifuge to precipitate the single-layer/few-layer MXene, thereby obtaining a single-layer/few-layer MXene-containing clay as a single-layer/few-layer MXene-containing sample.

### Comparative Example 4

In comparative example 4, after (1) preparation of the precursor (MAX) was performed in the same manner as in examples 1 to 4, (2) etching of the precursor and intercalation of Li, (3) washing, and (4) delamination were performed as described below, and a single-layer/few-layer MXene-containing sample was prepared without performing (5) acid treatment and (6) washing with water.

(1) Preparation of Precursor (MAX): Same as in Examples 1 to 4 μm)

(2) Etching of Precursor and Intercalation of Li

Precursor: Ti₃AlC₂ (sieving with a mesh size of 45 μm).

Etching solution composition: LiF 3g

HCl (9M) 30 mL

Amount of precursor input: 3 g

Etching container: 100 mL Aiboy

Etching temperature: 35° C.

Etching time: 24 h

Stirrer rotation speed: 400 rpm

(3) Washing

The slurry was divided into two portions, each of which was inserted into two 50 mL centrifuge tubes, centrifuged under the condition of 3500 G using a centrifuge, and then the supernatant was discarded. (i) 40 mL of pure water was added to the remaining precipitate in each centrifuge tube and (ii) centrifuged again at 3500 G to (iii) separate and remove the supernatant. The operations (i) to (iii) were repeated 10 times in total, it was confirmed that the pH of the 10th supernatant was more than 5, and the supernatant was discarded to obtain a Ti₃C₂Tₛ-moisture medium clay.

(4) Delamination

Next, (i) 40 mL of pure water was added to the Ti₃C₂Tₛ-moisture medium clay, and the mixture was stirred for 15 minutes with a shaker, then (ii) centrifuged at 3500 G, and (iii) the supernatant was recovered as a single-layer MXene-containing liquid. The operations (i) to (iii) were repeated 4 times in total to obtain a single-layer MXene-containing supernatant. Further, this supernatant was centrifuged under the conditions of 4300 G and 2 hours using a centrifuge, and then the supernatant was discarded to obtain a single-layer/few-layer MXene-containing clay as a single-layer/few-layer MXene-containing sample.

[Evaluation]

Using the single-layer/few-layer MXene-containing samples obtained in examples 1 to 4 and comparative examples 1 to 4, the Li content in the MXene particles and the major diameter and thickness of the two-dimensional surface of the MXene particles were measured. In addition, an MXene film was formed using each single-layer/few-layer MXene-containing sample, and R₀/R and initial conductivity for evaluation of resistance change were determined. Further, the MXene interlayer distance was measured using the MXene film. Details of each measurement method will be described below.

(Measurement of Li Content in MXene Particles)

MXene was made into a solution by an alkali melting method, and the Li content was measured by ICP-AES (iCAP 7400 manufactured by Thermo Fisher Scientific) using inductively coupled plasma atomic emission spectrometry. The results are shown in Table 3.

(Measurement of Major Diameter and Thickness of Two-Dimensional Surface of MXene Particle)

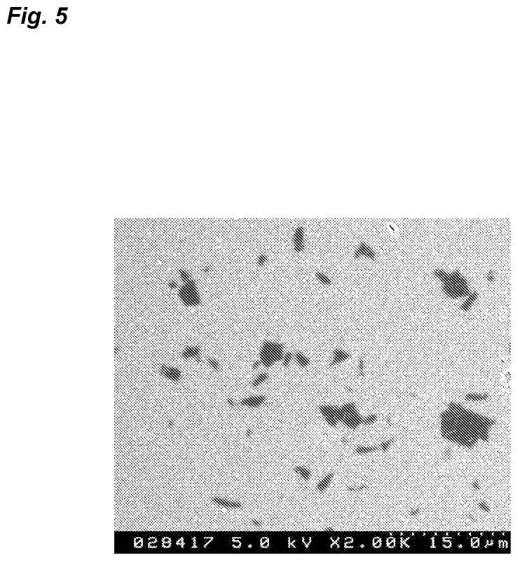

The major diameter (flake size) of the two-dimensional surface of MXene obtained in example 1 was measured by SEM. Specifically, the MXene slurry was applied to an alumina porous substrate and dried, and a scanning electron microscope (SEM) photograph was taken to perform measurement. Specifically, MXene particles of 80 or more particles that can be visually confirmed in a field of view (about 1 field to 3 fields) of one or more SEM images having a magnification of 2,000 times and a field size of 45 μm×45 μm were targeted. When a porous substrate is used as the substrate, fine black spots in the micrograph may be derived from the substrate. The background porous portion was removed by image processing, and thereafter, image analysis was performed using SEM image analysis software “A-Zou Kun” (registered trademark, manufactured by Asahi Kasei Plastics Co., Ltd.). In the image analysis, the major diameter when each MXene particle was approximated to an elliptical shape was obtained, and the number average thereof was taken as the average value (average particle diameter) of the major diameters of the two-dimensional surface. For examples 2 to 4, comparative example 3, and comparative example 4, the average value (average particle diameter) of the major diameters of the two-dimensional surfaces was determined in the same manner as in example 1. The measurement results are shown in Table 2. FIG. 5 illustrates a SEM photograph of example 1. In FIG. 5, the black particles are MXene particles.

In addition, the thickness of MXene particles of some examples was measured using an atomic force microscope (AFM) of Dimensin FastScan manufactured by Burker Corporation. Specifically, the MXene slurry was applied to a silicon substrate and dried, an atomic force microscope (AFM) photograph was taken, and the thickness was determined from the image. The results are shown in Table 2.

Table 2 shows that all the MXene particles of examples 1 to 4 have a larger average particle diameter than that of the comparative example.

Although the average particle diameter and the average thickness of comparative examples 1 and 2 were not measured, the average particle diameter and the average thickness of comparative examples 1 and 2 are considered to be at the same level as those of example 1 and the like because the initial conductivity measured by forming an MXene film (conductive film) is high as described later.

TABLE 2

| | Average particle | Average |
|---|---|---|
| | diameter | thickness |
| Sample | (μm) | (nm) |
| Comparative | 1.1 | 2.5 |
| Example 3 | | |
| Comparative | 2.0 | 3.0 |
| Example 4 | | |
| Example 1 | 2.7 | 5.6 |
| Example 2 | 2.5 | 6.4 |
| Example 3 | 3.0 | 6.0 |
| Example 4 | 2.2 | 7.5 |

[Production of MXene Film]

The single-layer/few-layer MXene-containing sample of each example was subjected to suction filtration. After the filtration, vacuum drying was performed at 80° C. for 24 hours to prepare an MXene film. As a filter for suction filtration, a membrane filter (Durapore, manufactured by Merck KGaA, pore size 0.45 μm) was used. The supernatant contained 0.05 g of solid content of MXene particles and 40 mL of pure water. The resistivity of the obtained MXene film was measured as follows to determine R₀/R and initial conductivity.

(Measurement of R₀/R and Initial Conductivity of MXene Film)

The initial conductivity of the obtained MXene film was determined. The surface resistivity was first measured at three points per sample, and this was defined as R₀(Ω). For surface resistivity measurement, the surface resistance of the film was measured by a four-terminal method using a simple low resistivity meter (Loresta AX MCP-T370, manufactured by Mitsubishi Chemical Analytech Co., Ltd.). In addition, the thickness (μm) was measured at three points per sample. A micrometer (MDH-25 MB, manufactured by Mitutoyo Corporation) was used for the thickness measurement. Then, the volume resistivity was determined from the obtained surface resistivity and film thickness, and the initial conductivity (S/cm) was calculated by taking the reciprocal of the value. The average value of the initial conductivities at the above three points was adopted. The results are shown in Table 3.

In addition, the MXene film was prepared, a small amount of water was put into the bottom of a sealed desiccator in the same manner as in the test apparatus illustrated in FIG. 5c of Non-Patent Document 1, the MXene film was placed so as not to be brought into direct contact with the water, the MXene film was held in a humid environment at room temperature and saturated with humidity for 14 days, and then the surface resistivity was measured at 3 locations per sample in the same manner as described above, and this was defined as R(Ω)). Then, R₀/R at the above three points was obtained. The results are shown in Table 3.

TABLE 3

| | Li content in | Resistance | Initial |
|---|---|---|---|
| | Mxene particles | change | conductivity |
| Sample | (mass %) | (R₀/R) | (S/cm) |
| Comparative | 0.0035 | 79 | 9400 |
| Example 1 | | | |
| Comparative | 0.005 | 78 | 9000 |
| Example 2 | | | |
| Comparative | 0 | 36 | 1000 |
| Example 3 | | | |
| Comparative | 0 | — | — |
| Example 4 | | | |
| Example 1 | 0.0004 | 92 | 4000 |
| Example 2 | 0.0001 | 92 | 3500 |
| Example 3 | 0.0010 | 95 | 3400 |
| Example 4 | 0.0020 | 92 | 2500 |

(Measurement of MXene Interlayer Distance)

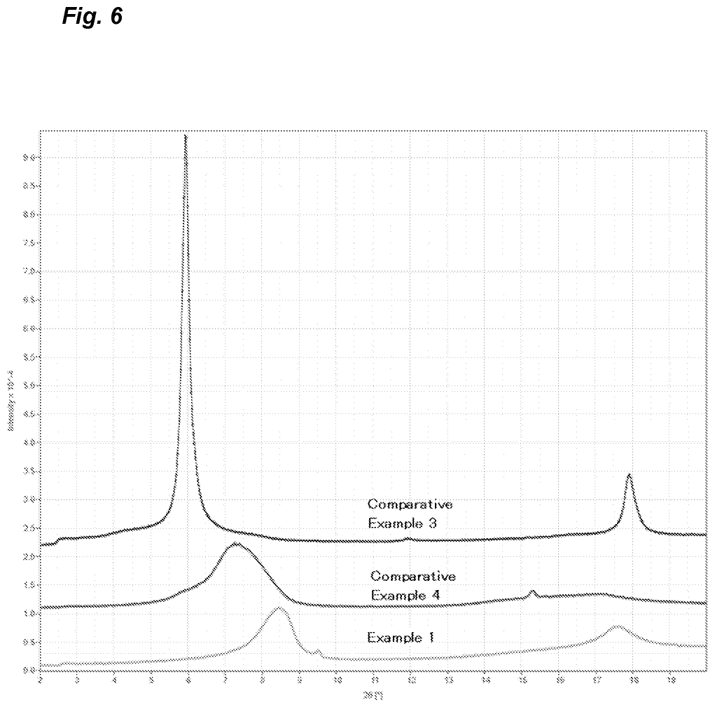

The interlayer distance of MXene can also be measured using conductive two-dimensional particles, but in this example, the interlayer distance of MXene was measured using an MXene film. More specifically, the MXene films of example 1, comparative example 3, and comparative example 4 were subjected to XRD measurement under the following conditions to obtain two-dimensional X-ray diffraction images of the MXene films. Then, the peak position of the (002) plane in the XRD profile was determined. The results are illustrated in FIG. 6.

(XRD Measurement Conditions)

Equipment used: MiniFlex 600 manufactured by Rigaku Corporation

Conditions

Light source: Cu tube bulb

Characteristic X-ray: CuKα=1.54 Å

Measurement range: 3 degrees to 20 degrees

Step: 50 step/degree

Sample: Filtration film

In FIG. 6, in example 1, since Li in the MXene particles was sufficiently reduced by performing the treatment of removing Li, the peak of the (002) plane was on the high angle side, and the interlayer was narrowed. On the other hand, in comparative example 3, since Li was not contained but TMAOH (organic dispersant) was contained, the peak of the (002) plane was on the low angle side, and the interlayer distance was widened. In comparative example 4, the treatment of removing Li was not performed as in example 1, and a large amount of Li remained, so that the peak was on the lower corner side than in example 1, and the interlayer was widened.

From the results of Table 3 and FIG. 6 above, by setting the Li content in the MXene particles to 0.0020 mass % or less, the resistance change was significantly reduced, and the resistance change rate was 10% or less. As a result, it can be said that the moisture absorption resistance was significantly improved. In the conductive two-dimensional particles of the present embodiment, the average value of the major diameters of the two-dimensional surfaces was 1.0 μm or more, and the conductive film formed of the conductive two-dimensional particles had a conductivity of 2,000 S/cm or more and exhibited high conductivity. When the amount of the Li-containing compound used as the intercalation is small in the production of the conductive two-dimensional particles, it is difficult to form a single layer of MXene. However, according to the method for producing conductive two-dimensional particles of the present embodiment, since the Li-containing compound is sufficiently removed after forming a single layer of MXene with a sufficient amount of the Li-containing compound, MXene particles having a sufficiently small resistance change can be produced without hindering the formation of a single layer of MXene.

The conductive two-dimensional particles and the conductive film of the present invention can be used in any suitable application, and can be preferably used, for example, as electrodes in electrical devices.

### REFERENCE NUMERALS

1a, 1b layer body (MₘXₙ layer)
3a, 5a, 3b, 5b modifier or terminal T
7a, 7b MXene layer
10, 10a, 10b MXene particles (conductive two-dimensional particle, particles of layered material)
20 titanium atom
21 oxygen atom
30a, 30b conductive film

1. A conductive two-dimensional particle of a layered material comprising one or more layers, wherein the one or more layers include a layer body represented by:
MₘXₙ
wherein M is at least one metal of Group 3, 4, 5, 6, or 7,
X is a carbon atom, a nitrogen atom, or a combination thereof,
n is 1 to 4,
m is more than n and 5 or less, and
a modifier or terminal T exists on a surface of the layer body, wherein T is at least one selected from the group consisting of a hydroxyl group, a fluorine atom, a chlorine atom, an oxygen atom, or a hydrogen atom,
a Li content is 0.0001 mass % to 0.0020 mass %, and
an average value of major diameters of two-dimensional surfaces of the conductive two-dimensional particles is 1.0 μm to 20 μm.

2. The conductive two-dimensional particle according to claim 1, wherein a peak of a (002) plane of the conductive two-dimensional particle obtained by X-ray diffraction measurement is 8.0° or more.

3. The conductive two-dimensional particle according to claim 1, wherein the Li content is 0.0001 mass % to 0.0010 mass %.

4. The conductive two-dimensional particle according to claim 1, wherein the average value of the major diameters of the two-dimensional surfaces of the conductive two-dimensional particles is 1.0 μm to 10 μm.

5. The conductive two-dimensional particle according to claim 1, wherein an average value of thicknesses of the conductive two-dimensional particles is 1 nm to 10 nm.

6. A conductive film comprising the conductive two-dimensional particle according to claim 1, wherein a conductivity of the conductive film obtained by substituting a thickness of the conductive film measured with a micrometer, a scanning electron microscope (SEM), or a stylus surface profiler and a surface resistivity of the conductive film measured by a four-point probe method into the following formula:
Conductivity [S/cm]=1/(thickness [cm] of conductive film×surface resistivity [Ω/sq.] of conductive film)
is 2,000 S/cm or more.

7. A conductive film containing a conductive two-dimensional particle of a layered material comprising one or more layers, wherein the one or more layers include a layer body represented by:
MₘXₙ
wherein M is at least one metal of Group 3, 4, 5, 6, or 7,
X is a carbon atom, a nitrogen atom, or a combination thereof,
n is 1 to 4, and
m is more than n and 5 or less, and
a modifier or terminal T exists on a surface of the layer body, wherein T is at least one selected from the group consisting of a hydroxyl group, a fluorine atom, a chlorine atom, an oxygen atom, or a hydrogen atom, and
a Li content in the conductive two-dimensional particle is 0.0001 mass % to 0.0020 mass %, and a conductivity of the conductive film is 2,000 S/cm or more.

8. A method for producing a conductive two-dimensional particle, the method comprising:
(a) preparing a precursor, the precursor represented by:
MₘAXₙ
wherein M is at least one metal of Group 3, 4, 5, 6, or 7,
X is a carbon atom, a nitrogen atom, or a combination thereof,
A is at least one element of Group 12, 13, 14, 15, or 16,
n is 1 to 4, and
m is more than n and 5 or less;
(b1) performing an etching treatment by removing at least a part of the A atoms from the precursor using an etching solution;
(c) performing Li intercalation treatment that includes mixing and stirring an etched product obtained by the etching treatment and a Li-containing compound;
(d) performing a delamination treatment that includes centrifuging a Li intercalated product obtained by the Li intercalation treatment, discarding a supernatant, and then washing a remaining precipitate with water;
(e) performing an acid treatment that includes mixing and stirring a delaminated product obtained by the delamination treatment and an acid solution; and
(f) washing an acid-treated product obtained by the acid treatment with water to obtain a conductive two-dimensional particle,
wherein a Li content in the conductive two-dimensional particles is 0.0020 mass % or less.

9. The method for producing a conductive two-dimensional particle according to claim 8, wherein pH of the acid solution is 2.5 or less.

10. The method for producing a conductive two-dimensional particle according to claim 8, wherein, in the acid treatment, steps of mixing the acid solution, stirring and centrifuging the mixture, and removing a supernatant are repeated.

11. A method for producing a conductive two-dimensional particle, the method comprising:
(a) preparing a precursor, the precursor represented by:
MₘAXₙ
wherein M is at least one metal of Group 3, 4, 5, 6, or 7,
X is a carbon atom, a nitrogen atom, or a combination thereof,
A is at least one element of Group 12, 13, 14, 15, or 16,
n is 1 to 4, and
m is more than n and 5 or less;
(b2) etching at least a part of A atoms from the precursor and performing a Li intercalation treatment using an etching solution containing Li-containing compound;
(d) performing a delamination treatment that includes centrifuging the etched and Li intercalated product obtained by the etching and Li intercalation treatment, discarding a supernatant, and then washing a remaining precipitate with water;
(e) performing an acid treatment that includes mixing and stirring a delaminated product obtained by the delamination treatment and an acid solution; and
(f) washing an acid-treated product obtained by the acid treatment with water to obtain a conductive two-dimensional particle,
wherein a Li content in the conductive two-dimensional particles is 0.0020 mass % or less.

12. The method for producing a conductive two-dimensional particle according to claim 11, wherein pH of the acid solution is 2.5 or less.

13. The method for producing a conductive two-dimensional particle according to claim 11, wherein in the acid treatment, steps of mixing the acid solution, stirring and centrifuging the mixture, and removing a supernatant are repeated.

14. A conductive composite material comprising:
the conductive two-dimensional particle of claim 1; and
a polymer.

15. The conductive composite material according to claim 14, wherein a peak of a (002) plane of the conductive two-dimensional particle obtained by X-ray diffraction measurement is 8.0° or more.

16. The conductive composite material according to claim 14, wherein the Li content is 0.0001 mass % to 0.0010 mass %.

17. The conductive composite material according to claim 14, wherein the average value of the major diameters of the two-dimensional surfaces of the conductive two-dimensional particles is 1.0 μm to 10 μm.

18. The conductive composite material according to claim 14, wherein an average value of thicknesses of the conductive two-dimensional particles is 1 nm to 10 nm.

19. A conductive paste comprising the conductive two-dimensional particle of claim 1.
